(19) United States
(12) Patent Application Publication
(10) Pub. No.: US 2025/0239007 A1
(43) Pub. Date: Jul. 24, 2025

(54) THREE-DIMENSIONAL STRUCTURE RECONSTRUCTION SYSTEMS AND METHODS

(71) Applicant: INTUITIVE SURGICAL OPERATIONS, INC., Sunnyvale, CA (US)

(72) Inventors: Shiyang Chen, Sunnyvale, CA (US); Jorge Anton Garcia, San Francisco, CA (US); Hui Zhang, San Jose, CA (US)

(21) Appl. No.: 18/854,018

(22) PCT Filed: Mar. 31, 2023
(86) PCT No.: PCT/US2023/017145

§ 371 Date: Oct. 3, 2024

Related U.S. Application Data
(60) Provisional application No. 63/327,133, filed on Apr. 4, 2022.

(51) Int. Cl. G06T 17/00

(52) U.S. Cl. CPC G06T 17/00; G06T 2207/10116

(57) ABSTRACT

Three-dimensional structure reconstruction systems and related methods are disclosed. In some examples, a three-dimensional structure reconstruction system may include at least one processor configured to: receive a plurality of X-ray images of an object, wherein the plurality of X-ray images are taken at a plurality of poses relative to the object; determine a loss function based on: an estimated three-dimensional structure, and the plurality of X-ray images of the object; and determine a reconstructed three-dimensional structure by minimizing the loss function. In some examples, at least one non-transitory computer-readable medium may have instructions thereon that, when executed by at least one processor, perform a method for three-dimensional structure reconstruction. In some examples, a method may include receiving X-ray images of an object; determining a loss function based on: an estimated three-dimensional structure, and the X-ray images; and determining a reconstructed three-dimensional structure by minimizing the loss function.

### CROSS-REFERENCED APPLICATIONS

This application claims priority to and benefit of U.S. Provisional Application No. 63/327, 133, filed Apr. 4, 2022 and entitled “Three-Dimensional Structure Reconstruction Systems and Methods,” which is incorporated by reference herein in its entirety.

### FIELD

Disclosed examples are related to three-dimensional structure reconstruction systems and methods

### BACKGROUND

C-arm machines are often used to take X-rays of a patient on a platform. Manual C-arm machines permit an operator to manually rotate the C-arm around a patient to get images at various positions and orientations relative to a subject.

### SUMMARY

In one example, a three-dimensional structure reconstruction system may comprise at least one processor configured to: receive a plurality of X-ray images of an object, wherein the plurality of X-ray images are taken at a plurality of poses relative to the object; determine a loss function based on: an estimated three-dimensional structure, and the plurality of X-ray images of the object; and determine a reconstructed three-dimensional structure by minimizing the loss function.

In another example, at least one non-transitory computer-readable medium may have instructions thereon that, when executed by at least one processor, perform a method for three-dimensional structure reconstruction, the method comprising: receiving a plurality of X-ray images of an object, wherein the plurality of X-ray images are taken at a plurality of poses relative to the object; determining a loss function based on: an estimated three-dimensional structure, and the plurality of X-ray images of the object; and determining a reconstructed three-dimensional structure by minimizing the loss function.

In yet another example, a method for three-dimensional structure reconstruction may comprise: receiving a plurality of X-ray images of an object, wherein the plurality of X-ray images are taken at a plurality of poses relative to the object; determining a loss function based on: an estimated three-dimensional structure, and the plurality of X-ray images of the object; and determining a reconstructed three-dimensional structure by minimizing the loss function.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting examples when considered in conjunction with the accompanying figures.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1A is an illustration of an exemplary C-arm imaging system, in accordance with embodiments of the present disclosure.

FIG. 1B is an illustration of an exemplary imaging system being operated with a subject in place, in accordance with embodiments of the present disclosure.

FIG. 2 is a flowchart illustrating a method used to reconstruct a three-dimensional structure, in accordance with embodiments of the present disclosure.

FIG. 3 is a series of images showing generated two-dimensional projections compared with original captured X-ray images, as well as comparisons between gradients thereof, in accordance with embodiments of the present disclosure.

FIG. 4 is a series of images showing the increase in detail shown in generated two-dimensional projections, in accordance with embodiments of the present disclosure.

### DETAILED DESCRIPTION

In certain applications, users (such as medical practitioners) look at two-dimensional views output from a C-arm system and make educated guesses at the shapes and positions of objects and anatomical structures in the different views. However, two-dimensional fluoro-images (which are often produced by these systems) have no depth information due to overlap of different portions of the three dimensional structure within the images. As a result, it is very difficult or impossible to tell the three-dimensional relative pose of a surgical tool relative to a target on the subject (such as a lesion), so guesswork is often needed by users employing manual C-arm imaging systems. This is due to conventional manual two-dimensional C-arm systems not measuring or tracking the reference frame and pose of the images relative to each other unlike CT scanners and automated C-arm machines. As a result, typical image reconstruction methods cannot be used on the stream of images taken of the subject with a conventional manual C-arm.

As such, it may be desirable to improve localization, especially of the relative position of an end effector of a surgical tool (e.g., a biopsy needle or other desirable end effector) and the target (e.g., a lesion on an organ of the subject). Furthermore, it may be desirable to permit three-dimensional reconstruction of objects located in the field of view of an imaging system, even if the pose of the different images relative to each other is unknown. As a result, it may be possible to provide a usable three-dimensional representation of a target (e.g., a lung or other portion of a subject's body) from the standard output of relatively inexpensive medical imaging devices (e.g., a conventional manual two-dimensional C-arm system).

In view of the above, by employing particular reconstruction techniques as described in some embodiments herein, various improvements to localization and three dimensional reconstruction from an image stream can be made, with resulting improvements to surgical operations. For example, the inventors have recognized and appreciated that better localization may be achieved using some embodiments than is conventionally possible.

In some embodiments, a system may receive a series of sequential two-dimensional images (such as X-ray fluoro-images) captured from different sequential positions and orientations relative to a subject. These images may be used to reconstruct the three-dimensional structure being imaged, including, for example a portion of a subject's body and an associated instrument interacting with the subject's body. Additionally, the system may (in some embodiments) recover the projection parameters associated with these received two-dimensional images, such that simulated two-dimensional images generated as part of the reconstruction process match with the received images. In some embodiments, no additional positional sensors or fiducial markers are needed for any of these processes in some embodiments.

In one specific embodiment, a plurality of X-ray images of an object are received. This may be done either using real-time capture of the images, receiving a transmission or download of the images, or any other appropriate method for obtaining the images. These images may correspond to images of an object, or multiple objects, within a field of view of an X-Ray imaging device that are taken at a plurality of different poses relative to the object. In some embodiments, the images may be taken at sequential poses relative to the object. Comparisons between an estimated three dimensional structure and the plurality of X-ray images may be used to determine information related to the different poses associated with the images which may permit a three dimensional structure to be reconstructed. For example, a loss function based on an estimated three dimensional structure and the plurality of X-ray images may be used to reconstruct a three dimensional structure corresponding to the object in some embodiments.

The received images used in the various embodiments described herein may have any appropriate resolution. For example, the received images may have a resolution of at least 256 pixels by 256 pixels. In some embodiments, the received images may have a resolution of at least 512 pixels by 512 pixels. In some embodiments, the received images may have a resolution of at most 2048 pixels by 2048 pixels. For example, the received images may have a resolution of between or equal to 256 pixels by 256 pixels and 2048pixels by 2048 pixels. While specific resolutions are noted above any appropriate resolution may be used for the images described herein.

A reconstructed structure may have any appropriate resolution. For example, a reconstructed structure may have a voxel resolution of at least 16 voxels by 16 voxels by 16 voxels. In some embodiments, the reconstructed structure may have a voxel resolution of at least 512 voxels by 512 voxel is by 512 voxels. In some embodiments, the reconstructed structure may have a resolution of at most 1024 voxels by 1024 voxels by 1024 voxels. For example, the reconstructed structure may have a resolution between or equal to 16 voxels by 16 voxels by 16 voxels and 1024 voxels by 1024 voxels by 1024 voxels. 512 pixels by 512 pixels by 512 pixels. While a specific resolution for a reconstructed structure are noted above, any appropriate resolution may be used. Additionally, as elaborated on below, an increasing resolution for a reconstructed structure may be implemented using a coarse to fine analysis process as elaborated on below.

In the various embodiments disclosed herein, a C-arm 110 may be configured to rotate through any suitable range of angles. For example, typical C-arms may be configured to rotate up to angles between or equal to 180 degrees and 270 degrees around an object, e.g., a subject on an imaging table. As elaborated on further below, in some embodiments, scans can be conducted over an entirety of such a rotational range of a C-arm. Alternatively, scans can be conducted over a subset of the rotational range of the system that is less than a total rotational range of the system. For example, a scan might be conducted between 0 degrees and 90 degrees for a system that is capable of operating over a rotational range larger than this. While specific rotational ranges are noted above, the systems and methods disclosed herein may be used with any appropriate rotational range.

Some embodiments may be widely usable and applicable with simple and commonly used inputs from manually operated C-arm machines. Some embodiments may operate even without additional imaging hardware. For example, some embodiments could be installed as part of the scanner's firmware or software, or used independently by transferring the images to a device separate from the C-arm machine. Thus, the disclosed embodiments may provide an inexpensive alternative to an automated three-dimensional C-arms, which are less common and significantly more expensive than a manual two-dimensional C-arm machine.

While specific dimensions and ranges for various components and aspects of the systems and methods disclosed herein are described both above and elsewhere in the current disclosure, it should be understood that dimensions both greater than and less than those noted herein may be used.

Embodiments herein may be used with the imaging and localization of any medical device, including robotic assisted endoscopes, catheters, and rigid arm systems. In some instances, the techniques disclosed herein may be used in manually operated systems, robotic assisted surgical systems, teleoperated robotic surgical systems, and/or other desired applications. The disclosed techniques are not limited to use with only these specific applications. For example, while the disclosed methods are primarily described as being used with C-arm systems used to take X-ray images at different poses relative to a subject, the disclosed methods may be used with any X-ray imaging system that takes x-ray images at different poses relative to an object being imaged by the system.

The received images and/or the output of the disclosed processes may correspond to any desirable format. However, in some embodiments, the received and/or output images may be in Digital Imaging and Communications in Medicine (DICOM) format, or some other standard format. The format can be browsed (e.g., like a CT scan), may be widely compatible with other systems and software, and may be easily saved to storage and viewed later.

As used herein, the term “position” refers to the location of an element or a portion of an element in a three-dimensional space (e.g., three degrees of translational freedom along cartesian x-, y-, and z-coordinates). As used herein, the term “orientation” refers to the rotational placement of an element or a portion of an element (three degrees of rotational freedom—e.g., roll, pitch, and yaw, angle-axis, rotation matrix, quaternion representation, and/or the like). As used herein, the term “pose” refers to the multi-degree of freedom (DOF) spatial position and orientation of a coordinate system of interest (e.g., attached to a rigid body). In general, a pose includes a pose variable for each of the DOFs in the pose. For example, a full 6-DOF pose would include 6 pose variables corresponding to the 3 positional DOFs (e.g., x, y, and z) and the 3 orientational DOFs (e.g., roll, pitch, and yaw).

Turning to the figures, specific non-limiting examples are described in further detail. The various systems, components, features, and methods described relative to these examples may be used either individually and/or in any desired combination and is not limited to only the specific examples described herein.

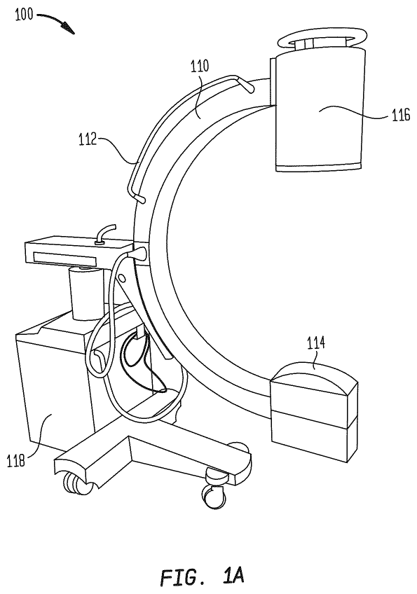

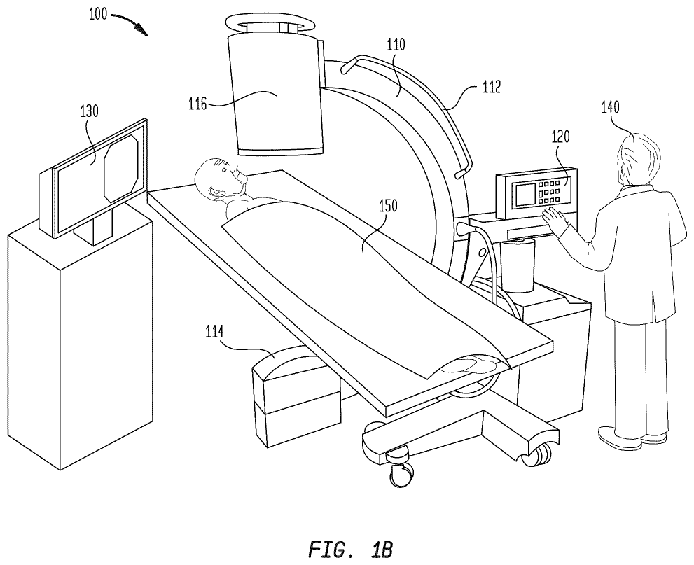

FIG. 1A is an illustration of an exemplary two-dimensional C-arm imaging system 100, in accordance with embodiments of the present disclosure. The imaging system 100 may be configured for imaging any desired object. In examples in which the imaging system is a medical imaging system, the object to be imaged may correspond to tissue of a subject such as a site within a natural cavity and/or surgical site of a subject. The imaging system 100 includes a manual C-arm 110 operatively coupled to a source 114, a detector 116, and a controller 120. In some embodiments, the source 114 may be configured to emit X-rays towards the detector which may be configured to detect an X-ray image of an object disposed between the source 114 and the detector 116. In some embodiments, the controller 120 may be operatively coupled with the detector 116 such that it receives a stream of images from the detector 116. The C-arm 110 may also be rotatably coupled to a base 118 configured to support the overall C-arm imaging system. In some embodiments, the imaging system 100 includes a manual handle 112 attached to the C-arm 110 that may be used by an operator to control a pose of the C-arm 110, as well as the source 114 and the detector 116, as they are rotated relative to the base 118 and an object disposed between the source 114 and detector 116. While the disclosed embodiments are primarily directed to a manually operated C-arm, in some embodiments, the pose of the C-arm 110 may be controlled programmatically or by a user via a user input device.

FIG. 1B is an illustration of an exemplary imaging system being operated with a subject in place, in accordance with embodiments of the present disclosure. FIG. 1B shows a manual C-arm imaging system 100 with a C-arm 110, source 114, detector 116, and manual handle 112 similar to that described above. In some embodiments, the imaging system 100 includes and a display 130. FIG. 1B also shows an exemplary operator 140 operating the manual handle 112 and an exemplary subject 150 being scanned by the imaging system 100. The source 114 and detector 116 are rotatable around the subject as a pair. As noted above, the C-arm 110, as well as the associated detector 116 and source 114, are rotatable such that they may be moved through a plurality of different poses relative to the subject 150, or other object disposed between the source 114 and detector 116. Thus, the source 114 and detector 116 may be used to obtain a stream of sequential x-ray images of the subject 150, or other object, at a plurality of poses relative to the subject 150 as the C-arm 110 is manually rotated by the operator 140 between an initial and final pose. As noted above, this may correspond to rotation between any desired poses including rotation over and entire rotational range of the C-arm 110 or a portion of the rotational range of the C-arm 110.

In some embodiments, a three-dimensional structure reconstruction system as described herein may be part of the controller 120 of the imaging system 100. Alternatively or additionally, the three-dimensional structure reconstruction system may be part of a separate computer, such as a desktop computer, a portable computer, and/or a remote or local server. In some embodiments, the three-dimensional structure reconstruction system may include at least one processor, such as the controller 120. In some embodiments, the processor may be configured to receive images of an object. For example, the images may be X-ray fluoro-images obtained from a C-arm imaging system as described above. Additionally, the object may be a human subject or some organ of the subject. In some embodiments, the received images of the object may have been taken by an imaging device (e.g., detector 116) from different perspectives. For example, the images may have been taken at different poses of the imaging device relative to the object, such as from different positions and orientations. These images taken at different positions and orientations of the imaging device may be obtained via movement of the C-arm 110 (e.g., as may be controlled by an operator via the manual handle 112 or in some other way) that is attached to the source 114 and detector 116.

In some embodiments, an initial estimate of the three-dimensional structure may be made. In some embodiments, an initial estimate of the projection parameters related to the different poses (e.g., captured using different orientations and positions of an imaging device in some embodiments) of the received images may also be made. The projection parameters are values that define the perspective of the detector and/or source relative to an object to provide the one or more captured images. For example, each image may capture an object from a perspective defined by one or more projection parameters, such as such as angular position, an orientation angle, a position, etc. In some embodiments, these initial estimates need not be accurate or even close to the actual values. Rather, a very rough “guess” is acceptable in some embodiments. In some embodiments, an initial estimate of the three-dimensional structure may be all zeroes or random numbers in the voxels of the reconstructed structure. For example, the estimated three-dimensional structure may initially comprise voxels having random or zero intensity.

In some embodiments, the initial estimated projection parameters may correspond to angular positions that are evenly distributed along a circular trajectory, such as from 0 to 180 degrees (e.g., for 100 frames taken over 180 degrees, each frame may be estimated as being 1.8 degrees from its neighboring frames). In some embodiments, a greater or smaller range of rotation may be used, which may be changed based on appropriate constraints.

In some embodiments, a better initial estimate of the projection parameters may be used, such as from an inertial measurement unit (IMU) sensor or fiducial based calibration, to fine-tune the reconstruction process. In such embodiments, the minimizing of the loss function described below may be accelerated by such fine-tuning. However, in some embodiments, the reconstructed three-dimensional structure is determined without relying on information derived from a positional sensor or a fiducial marker.

In some embodiments, an estimated three-dimensional structure may be projected into two-dimensional images using either estimated or determined projection parameters. For example, the initial estimated three-dimensional structure described above may be projected using the projection parameters into these two-dimensional images. In some embodiments, the projection operation may be differentiable to both the three-dimensional structure and the projection parameters. In some embodiments, projection parameters may include intrinsic parameters related to the imaging system (e.g., separation distances and orientation of a source and detector relative to one another) as well as parameters related to an interaction between the imaging system and an object being imaged including, for example, a position and orientation of a perspective or viewpoint from which the projection of an image has been or would have been made by the imaging system relative to an object.

In some embodiments, the received images may be 8-bit, image contrast may be changing, and/or some areas of the images may be over- or under-exposed. Information may be lost in this condition, and that this can be alleviated by modeling this process as a linear mapping using value clipping during the projection of the estimated three-dimensional structure into two-dimensional images.

In some embodiments, the processor may determine the projection parameters and the reconstructed three-dimensional structure. In some embodiments, the projection parameters and the reconstructed three-dimensional structure may be determined together temporally. For example, in addition to the three-dimensional structure being reconstructed, the projection parameters that were actually used in capturing the received images may be reconstructed, in some embodiments in the same process and at the same time as the three-dimensional structure is being reconstructed. For example, in some embodiments, the processor may determine a loss function based on the estimated three-dimensional structure and on the received images of the object. For example, the loss function may be determined by comparing the projected two-dimensional images with the received images. In some embodiments, the loss function may be a way to express and quantify the difference between the projected two-dimensional images and the received images.

In some embodiments, the above noted comparison comprises comparing a gradient of at least one of the two-dimensional images with a gradient of at least one of the received images. In some embodiments, the gradient may be obtained by shifting of at least a portion of the original image.

In some embodiments, the processor may determine a reconstructed three-dimensional structure by minimizing the loss function. For example, the processor may pass the gradient of the loss back to the three-dimensional structure and the projection parameters and update them. In some embodiments, minimizing the loss function may drive the loss or difference as low as possible. In some embodiments, derivatives of the loss function can be used, such as a first-order derivative. As a result, some embodiments make the projected images more similar to the received images with each iteration of the disclosed reconstruction process. In some embodiments, these iterations may continue including the steps of: 1) using the updated estimates of the projection parameters and reconstructed three dimensional structure to generated projected two-dimensional images; 2) compare the projected two-dimensional images to the captured images (e.g., using a loss function); and 3) updating the estimates of the projection parameters and reconstructed three dimensional structure based on this comparison (e.g., by minimizing the loss function) until the estimated projection parameters and reconstructed three dimensional structure converges, at which point the projected images and the received images may have at most a threshold degree of difference.

In some embodiments, an Adam optimizer may be used for this minimization or optimization. Alternatively or additionally, an Adadelta, Adagrad, AdamW, SparseAdam (a “lazy version” of an Adam algorithm suitable for sparse tensors), Adamax (a variant of Adam based on infinity norm), Averaged Stochastic Gradient Descent, L-BFGS, NAdam, RAdam, RMSprop, resilient backpropagation, stochastic gradient descent, DENSE_QR, DENSE_NORMAL_CHOLESKY, SPARSE_NORMAL_CHOLESKY, CGNR, DENSE_SCHUR, SPARSE_SCHUR, ITERATIVE_SCHUR, JACOBI, SCHUR_JACOBI, Levenberg-Marquardt, STEEPEST_DESCENT, NONLINEAR_CONJUGATE_GRADIENT, and/or BFGS may be used.

To help avoid being stuck in suboptimal solution for the above noted process, it may be desirable to implement a coarse-to-fine optimization with the disclosed reconstruction methods. This may help to improve an overall accuracy of the reconstructed structures. For example, the coarse-to-fine optimization may in some embodiments prevent the reconstruction process from being trapped in a local rather than a global solution or minimum. Several potential methods for implementing such a coarse-to-fine optimization method are detailed below.

In some embodiments, minimizing the loss function may comprise using a coarse-to-fine optimization. For example, coarse-to-fine optimization may comprise an initial lower resolution (e.g., 50 or less voxels) and a final resolution that is greater than the initial resolution (e.g., 200 or more voxels). The reconstructed structure may be determined for the coarser resolutions first using the reconstruction methods disclosed herein. The coarse reconstructed structure, and the associated projection parameters, may then be used as initial inputs for the next iteration of the process with an increased resolution until a desired final resolution is obtained.

In another embodiment, a coarse-to-fine optimization may be achieved using a total variation technique. For example, a way to compute total variation on a three-dimensional array is as follows: compute the distance of each voxel to its neighboring voxels and sum up all these distances; add this total variation to a weight coefficient and add it to the loss; at the beginning of the training, set the weight coefficient of total variation to be large so that the volume is forced to be smooth at the beginning; then gradually decrease the weight coefficient so that the volume can capture more details and thus lead to more accurate pose and volume estimation.

In some embodiments, coarse-to-fine optimization may include using a three-dimensional array and modeling a three-dimensional structure as an implicit neural representation. For example, a neural network may take a three-dimensional coordinate as an input and output a value representing the volume intensity at that coordinate. In some embodiments, the trainable parameters may be the parameters in the neural network, instead of the three-dimensional array. In some embodiments, if the volume is modeled as an implicit neural representation, the coarse-to-fine optimization can be achieved by altering the positional encoding in the neural network.

In some embodiments using coarse to fine optimization, at the beginning of optimization, focusing on details may be avoided. For example, downsampling and upsampling may be used in some implementations. In one such embodiment, initially, the three-dimensional structure, the received images, and the projection step may be downsampled based on the original resolution of the received images (for example, a factor of 32 may be used for downsampling). In some embodiments, every iteration, the three-dimensional structure, the received images, and the projection step may be upsampled (by a factor, for example, 2), to bring in detailed information gradually. The inventors have recognized and appreciated that this may help the optimization from getting stuck in a suboptimal solution.

In the above embodiments, the poses of the received images are not known, in other embodiments, a processor implementing the methods disclosed herein may receive the projection parameters (e.g., a pose and distance parameters) associated with the plurality of images. The system may then implement the reconstruction methods disclosed herein. For example, projection parameters and/or data related to poses of the images may be received (rather than generated) from an IMU, accelerometer, gyroscope, magnetometer, encoder, or other sensor configured to measure the pose of the C-arm during imaging. In some embodiments, the projection parameters do not need to be optimized if they have been received. For example, in some embodiments only the three-dimensional structure may be reconstructed, as the projection parameters have been received. In some embodiments, the initial estimate may correspond to the three-dimensional structure. For example, as explained above, the initial estimate may be all zeroes or random numbers, but the projection parameters may be at least approximately known from the noted measurements. In some embodiments, the three-dimensional structure may be projected into two-dimensional images based on the received projection parameters, similar to the projection described above.

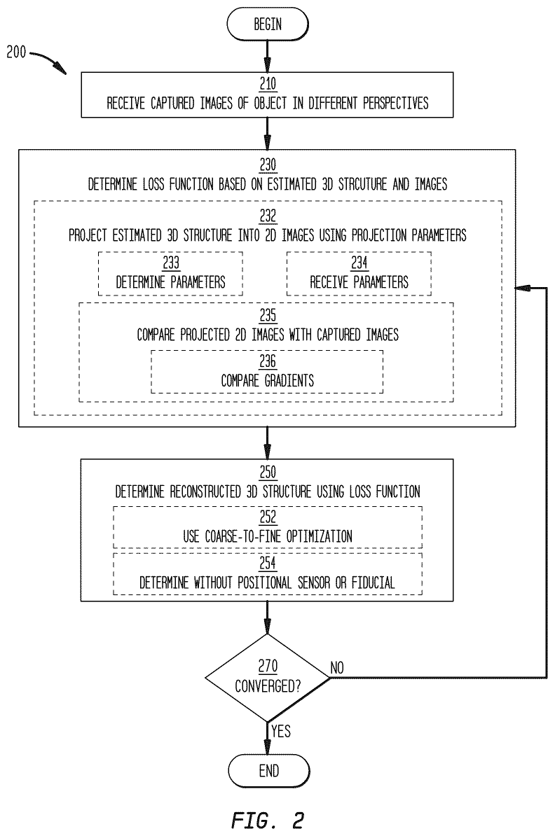

FIG. 2 is a flowchart illustrating a method 200 used to reconstruct a three-dimensional structure, according to an embodiment of the present disclosure. In some embodiments, the depicted method may be implemented using the processes, systems, and controllers described above. The method 200 is illustrated in FIG. 2 as a set of stages, blocks, steps, operations, or processes. Not all of the illustrated, enumerated operations may be performed in all embodiments of the method 200. Additionally, some additional operations that are not expressly illustrated in FIG. 2 may be included before, after, in between, or as part of the enumerated stages. Some embodiments of the method 200 include instructions corresponding to the processes of the method 200 as stored in a memory. These instructions may be executed by a processor, like a processor of a controller or control system.

Some embodiments of the method 200 may begin at stage 210, in which images of an object captured from different poses may be received. For example, the images may be taken at different poses of an imaging device (e.g., a detector of an imaging system), such as from different positions and/or orientations of the imaging device. In some embodiments, the object may be a human patient or subject and/or an organ of the patient or subject. In some embodiments, the images of the object may be X-ray images. In some embodiments, the images of the object may be taken at a plurality of poses relative to the object. In some embodiments, the plurality of images may be a series of sequential images that are taken from a plurality of sequential perspectives (corresponding with sequential poses of the imaging device) that are located along a path of motion of a detector of an imaging system relative to an object located within a field of view of the detector.

At stage 230, a loss function may be determined based on an estimated three-dimensional structure and the captured images of the object. In some embodiments, stage 230 may optionally include stage 232, in which an estimated three-dimensional structure may be projected into two-dimensional images using projection parameters related to the received images. In some embodiments, stage 232 may include stage 233, in which the projection parameters may be determined by the processor. Alternatively or additionally, stage 232 may include stage 234, in which the projection parameters may be received (for example, from a user input or measurement from an appropriate sensor).

For example, the estimated three-dimensional structure may initially comprise voxels having random or zero intensity, or some other values corresponding with an initial guess. The projection parameters used to generate the projected two-dimensional images may include initial projection parameters, such as projection parameters corresponding to angular positions that are (e.g., evenly) distributed along a semi-circular, or other appropriately shaped, trajectory (e.g., each angular position corresponding with a perspective), or some other values corresponding to an initial guess. If actual projection parameters that are used for capturing the images are known, then these projection parameters may be used as the initial projection parameters. The initial three-dimensional structure and the initial projection parameters are used to generate a projected two-dimensional image for each of the perspectives.

In some embodiments, stage 232 may optionally include stage 235, in which the projected two-dimensional images may be compared to the captured images of the object to determine the loss function. In some embodiments, stage 235 may optionally include stage 236, in which the comparison to determine the loss function may be a comparison between gradients of the projected two-dimensional images and gradients of the images of the object.

At stage 250, a reconstructed three-dimensional structure may be determined using the loss function using any of the methods disclosed herein. For example, this determination may be made by minimizing the loss function. In some embodiments, stage 250 may optionally include stage 252, in which coarse-to-fine optimization may be used. In some embodiments, stage 250 may optionally include stage 254, in which the method 200, including the determining of the three-dimensional structure, be performed without a positional sensor or fiducial. Here, reconstructed projection parameters may also be determined using the loss function, such as when the projection parameters are not measured values and instead are iteratively derived to correspond with the perspectives of the captured images via minimizing loss functions. In each iteration, the three-dimensional structure and/or projection parameters may be reconstructed to include values that minimize the difference (as defined by the loss function) between the projected two-dimensional images and the captured images.

In some embodiments, at least some portions of stages 230 and 250 may be repeated as needed, as described above. For example, the method 200 may then proceed to stage 270, in which a check may be made whether convergence has been reached, at which the difference between the captured images and the projected images, or other loss function, is within a threshold. If convergence has not occurred, the method 200 may return to at least some portion of stage 230 for a next iteration. For example, at stages 230 and 250 in the next iteration, the reconstructed three-dimensional structure (used as the estimated three-dimensional structure in the next iteration), reconstructed projection parameters (used as the determined projection parameters in the next iteration), and the captured images may be used to further refine the three-dimensional structure and/or projection parameters. In this iteration, the three-dimensional structure and/or projection parameters have reconstructed values that are more accurate than their initial values. Additional iterations will result in further improvement in accuracy for the reconstructed three-dimensional structure and/or projection parameters. Alternatively, if convergence has occurred, the method 200 may then end or repeat as needed.

### Example: Reconstruction of a Three Dimensional Structure

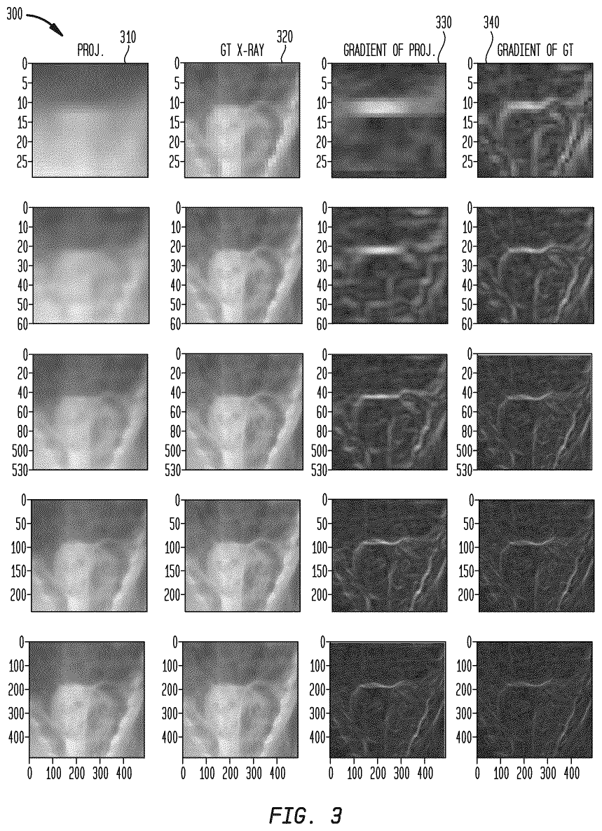

FIG. 3 shows a series of images showing generated two-dimensional projections 310 compared with received images 320, as well as comparisons between gradients thereof (330 and 340, respectively), in accordance with embodiments of the present disclosure. Similar to the process described above, the projections from an initial estimate of the three-dimensional structure as well as estimates of the projection parameters (e.g., orientation in this example) were refined over multiple iterations of minimizing the loss function associated with the illustrated gradients until the loss function converged (e.g., the difference in gradients between the projected and received images was less than a predetermined threshold). This provided a reconstructed structure that closely matched the actual imaged object as shown by the matching generated projected images and corresponding received images as well as the illustrated gradients in the final set of images.

### Example: Coarse-to-Fine Optimization

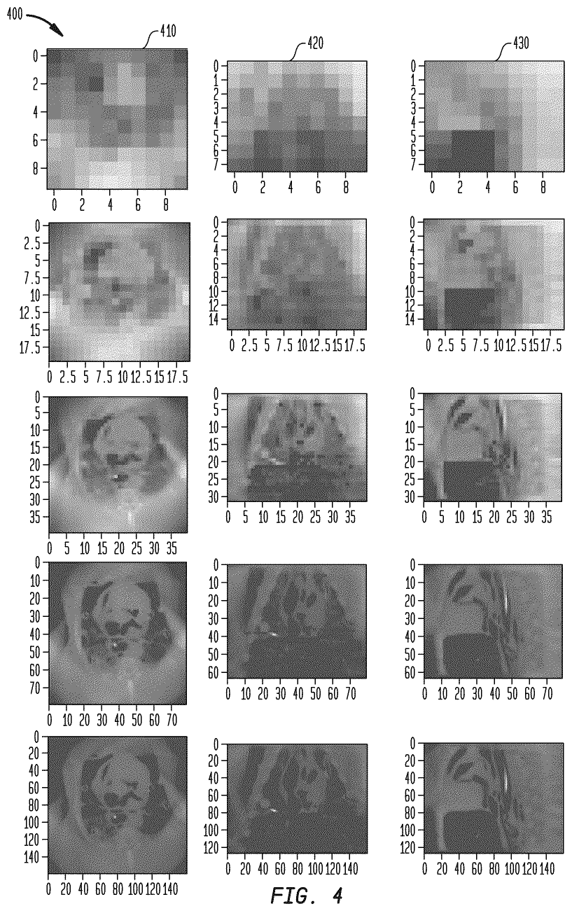

FIG. 4 is a series of images showing the increase in detail obtained during a coarse-to fine optimization shown in the generated two-dimensional projections in three different orientations (410, 420, and 430). An optimization similar to that shown relative to FIG. 3 and described elsewhere herein was used to determine an initial coarse reconstructed structure and projection parameters where the received images were modified to have an initial low resolution of 8 pixels by 8 pixels. The resulting coarse estimated reconstructed structure and projection parameters were then used as initial estimates for inputting into a subsequent iteration of the optimization process with increased resolution of the images and reconstructed structure. This iterative process was continued for resolutions of 16 pixels by 16 pixels, 32 pixels by 32 pixels, 64 pixels by 64 pixels, and 128 pixels by 128 pixels. However, the process may be conducted with any desired set of resolutions including resolutions both greater and less than those noted above.

One or more elements in embodiments of the current disclosure may be implemented in software to execute on a processor of a computer system such as controller 120. When implemented in software, the elements of the embodiments of the disclosure are essentially the code segments to perform the necessary tasks. The program or code segments can be stored in a processor readable storage medium or device that may have been downloaded by way of a computer data signal embodied in a carrier wave over a transmission medium or a communication link. The processor readable storage device may include any medium that can store information including an optical medium, semiconductor medium, and magnetic medium. Processor readable storage device examples include an electronic circuit, a semiconductor device, a semiconductor memory device, a read only memory (ROM), a flash memory, an erasable programmable read only memory (EPROM), a floppy diskette, a CD-ROM, an optical disk, a hard disk, or other storage device. The code segments may be downloaded via computer networks such as the Internet, Intranet, etc.

Note that the processes and displays presented may not inherently be related to any particular computer or other apparatus. The required structure for a variety of these systems will appear as elements in the claims. In addition, the embodiments of the disclosure are not described with reference to any particular programming language. It will be appreciated that a variety of programming languages may be used to implement the teachings of the disclosure as described herein.

While the present teachings have been described in conjunction with various examples, it is not intended that the present teachings be limited to such examples. On the contrary, the present teachings encompass various alternatives, modifications, and equivalents, as will be appreciated by those of skill in the art. Accordingly, the foregoing description and drawings are by way of example only.

1. A three-dimensional structure reconstruction system comprising:
at least one processor configured to:
receive a plurality of X-ray images of an object, wherein the plurality of X-ray images of the object are captured from different poses;
determine a loss function based on:
an estimated three-dimensional structure, and
the plurality of X-ray images of the object; and
determine a reconstructed three-dimensional structure by minimizing the loss function.

2. The system of claim 1, wherein the at least one processor is further configured to project the estimated three-dimensional structure into projected two-dimensional images using projection parameters.

3. The system of claim 2, wherein the at least one processor is further configured to determine reconstructed projection parameters by minimizing the loss function.

4. The system of claim 2, wherein the projection parameters and the reconstructed three-dimensional structure are determined together temporally.

5. The system of claim 2, wherein the projection parameters correspond with the different poses from which the plurality of X-ray images are captured.

6. The system of claim 2, wherein the at least one processor is configured to determine the projection parameters without using information derived from a positional sensor or a fiducial marker.

7. The system of claim 2, wherein the loss function defines a difference between the projected two-dimensional images and the plurality of X-ray images.

8. The system of claim 7, wherein determining the loss function comprises comparing a gradient of at least one of the two-dimensional images with a gradient of at least one of the plurality of X-ray images.

9. The system of claim 1, wherein minimizing the loss function comprises using a coarse-to-fine optimization.

10. The system of claim 9, wherein an initial three-dimensional structure comprises a resolution of 50 or less voxels and a subsequent three-dimensional structure generated using the coarse-to-fine optimization comprises a resolution of 200 or more voxels.

11. The system of claim 1, wherein the estimated three-dimensional structure initially comprises voxels having random or zero intensity.

12. The system of claim 1, wherein the at least one processor is further configured to project the estimated three-dimensional structure into projected two-dimensional images using projection parameters and the projection parameters initially comprise angular positions distributed along a trajectory.

13. At least one non-transitory computer-readable medium having instructions thereon that, when executed by at least one processor, perform a method for three-dimensional structure reconstruction, the method comprising:
receiving a plurality of X-ray images of an object, wherein the plurality of X-ray images of the object are captured from different poses;
determining a loss function based on:
an estimated three-dimensional structure, and
the plurality of X-ray images of the object; and
determining a reconstructed three-dimensional structure by minimizing the loss function.

14. The at least one non-transitory computer-readable medium of claim 13, wherein the method further comprises projecting the estimated three-dimensional structure into projected two-dimensional images using projection parameters.

15. The at least one non-transitory computer-readable medium of claim 14, wherein the method further comprises determining reconstructed projection parameters by minimizing the loss function.

16. The at least one non-transitory computer-readable medium of claim 14, wherein the projection parameters and the reconstructed three-dimensional structure are determined together temporally.

17-18. (canceled)

19. A method for three-dimensional structure reconstruction, the method comprising:
receiving a plurality of X-ray images of an object, wherein the plurality of X-ray images of the object are captured from different poses;
determining a loss function based on:
an estimated three-dimensional structure, and
the plurality of X-ray images of the object; and
determining a reconstructed three-dimensional structure by minimizing the loss function.

20. The method of claim 19, further comprising projecting the estimated three-dimensional structure into projected two-dimensional images using projection parameters.

21. The method of claim 20, further comprising determining reconstructed projection parameters by minimizing the loss function.

22. The method of claim 20, wherein the projection parameters and the reconstructed three-dimensional structure are determined together temporally.

23-24. (canceled)
